(19) United States
(12) Patent Application Publication
(10) Pub. No.: US 2026/0194374 A1
(43) Pub. Date: Jul. 9, 2026

(54) Devices, Systems, and Methods for Data Mapping

(71) Applicant: Dickson/Unigage, Inc., Addison, IL (US)

(72) Inventors: Matthew McNamara, Northbrook, IL (US); Antoine Nguyen, Highland Park, IL (US)

(73) Assignee: Dickson/Unigage, Inc., Addison, IL (US)

(21) Appl. No.: 19/439,183

(22) Filed: Jan. 2, 2026

Related U.S. Application Data
(60) Provisional application No. 63/741,809, filed on Jan. 3, 2025.

(51) Int. Cl. G01D 11/30; G01D 11/24

(52) U.S. Cl. CPC G01D 11/30; G01D 11/245

(57) ABSTRACT

A device is disclosed. The device includes a first portion, a second portion, and a sensor. The first portion includes a first housing having an exterior facet and an interior facet, a cleat within a channel on the interior facet, a depressible feature configured to operate the cleat, and a hook on an upper portion of the interior facet. The second portion includes a second housing having an interfacing facet and a retaining facet, a display on the interfacing facet, and a slot on an upper portion of the retaining facet such that the hook is configured to be received by the slot to couple the second portion to the first portion. The sensor is received in a sensor opening on the retaining facet.

### CROSS-REFERENCE TO RELATED APPLICATION

The present application claims priority to provisional U.S. Application No. 63/741,809 filed Jan. 3, 2025, the contents of which are hereby incorporated by reference in its entirety.

### BACKGROUND

Data mapping of an environment is the process of recording and mapping a parameter (e.g., temperature) within a three-dimensional (3D) space, such as cold and freezer chambers or rooms, stability chambers, dry storage areas, refrigerator and freezer units, walk-in chilled spaces, or other warehouse rooms. For example, temperature mapping may be used to identify hot or cold spots in a monitored space, which may assist with regulatory compliance in storage of certain goods, and reduce product degradation due to high temperatures.

Data mapping may be accomplished by installing data loggers in predetermined locations within a space to measure data, such as temperature and/or humidity, over a period of time within the space. The data may then be analyzed to identify parameter differences throughout the space, such as temperature differences or humidity differences.

However, in some cases there is not supporting structure (e.g., a rack or wall) to support the placement of a data logger in a specific location (e.g., latitude, longitude, and elevation) within the space. In such situations, additional structure, such as pallet racking, may be needed to be installed within the space to support the data logger at the specific location without interrupting other goods and structures within the space. But additional structure may be difficult to install, maintain, and adjust, especially in large-scale spaces.

### OVERVIEW

Disclosed herein is a data logging device, a method of securing a data logging device to a rope in an environment, and a system for mapping an environment. In one or more embodiments, the data logging device is affixed to a rope at a predetermined location in the environment.

One or more aspects of the disclosure provide a device. The device has a first portion. The first portion includes a first housing having an exterior facet and an interior facet, a cleat within a channel on the interior facet of the first housing such that the channel is configured to receive a portion of a rope, a depressible feature configured to operate the cleat, and a hook on an upper portion of the interior facet of the first housing. The device also has a second portion. The second portion includes a second housing having an interfacing facet and a retaining facet, a display on the interfacing facet of the second housing, and a slot on an upper portion of the retaining facet of the second housing such that the hook of the first portion is configured to be received by the slot of the second portion to couple the second portion to the first portion. The device further has a sensor. The sensor is received in a sensor opening on the retaining facet of the second portion. The sensor is configured to receive information regarding an input in an environment of the device.

One or more aspects of the disclosure provide a method. The method includes affixing a rope in an environment. The method also includes depressing a depressible feature of a device. The device has a first portion. The first portion includes a first housing having an exterior facet and an interior facet, a cleat within a channel on the interior facet of the first housing such that the channel is configured to receive a portion of a rope, a depressible feature configured to operate the cleat, and a hook on an upper portion of the interior facet of the first housing. The device also has a second portion. The second portion includes a second housing having an interfacing facet and a retaining facet, a display on the interfacing facet of the second housing, and a slot on an upper portion of the retaining facet of the second housing such that the hook of the first portion is configured to be received by the slot of the second portion to couple the second portion to the first portion. The device further has a sensor. The sensor is received in a sensor opening on the retaining facet of the second portion. The sensor is configured to receive information regarding an input in an environment of the device. The method also includes, while the depressible feature is depressed, installing the rope in the channel of the first portion. The method further includes releasing the depressible feature such that releasing the depressible feature secures the first portion to the rope. The method also includes coupling, via the slot and hook, the second portion to the first portion.

One or more aspects of the disclosure provide a system. The system includes two or more ropes. The system also includes at least two devices. Each device has a first portion. The first portion includes a first housing having an exterior facet and an interior facet, a cleat within a channel on the interior facet of the first housing such that the channel is configured to receive a portion of a rope, a depressible feature configured to operate the cleat, and a hook on an upper portion of the interior facet of the first housing. The device also has a second portion. The second portion includes a second housing having an interfacing facet and a retaining facet, a display on the interfacing facet of the second housing, and a slot on an upper portion of the retaining facet of the second housing such that the hook of the first portion is configured to be received by the slot of the second portion to couple the second portion to the first portion. The device further has a sensor. The sensor is received in a sensor opening on the retaining facet of the second portion. The sensor is configured to receive information regarding an input in an environment of the device.

One or more aspects of the disclosure provide a rope-clip assembly. The rope-clip assembly has a first portion. The first portion includes a first housing having an exterior facet and an interior facet, a cleat within a channel on the interior facet of the first housing such that the channel is configured to receive a portion of a rope, a depressible feature configured to operate the cleat, and a hook on an upper portion of the interior facet of the first housing. The rope-clip assembly also has a second portion. The second portion includes a second housing having an interfacing facet and a retaining facet, a display on the interfacing facet of the second housing, and a slot on an upper portion of the retaining facet of the second housing such that the hook of the first portion is configured to be received by the slot of the second portion to couple the second portion to the first portion.

One or more aspects of the disclosure provide a method. The method includes affixing a rope in an environment. The method also includes depressing a depressible feature of a rope-clip assembly. The rope-clip assembly has a first portion. The first portion includes a first housing having an exterior facet and an interior facet, a cleat within a channel on the interior facet of the first housing such that the channel is configured to receive a portion of a rope, a depressible feature configured to operate the cleat, and a hook on an upper portion of the interior facet of the first housing. The rope-clip assembly also has a second portion. The second portion includes a second housing having an interfacing facet and a retaining facet, a display on the interfacing facet of the second housing, and a slot on an upper portion of the retaining facet of the second housing such that the hook of the first portion is configured to be received by the slot of the second portion to couple the second portion to the first portion. The method also includes, while the depressible feature is depressed, installing the rope in the channel of the first portion. The method further includes releasing the depressible feature such that releasing the depressible feature secures the first portion to the rope. The method also includes coupling, via the slot and hook, the second portion to the first portion.

Other embodiments will become apparent to those of ordinary skill in the art by reading the following detailed description, with reference where appropriate to the accompanying drawings.

### BRIEF DESCRIPTION OF THE DRAWINGS

Example embodiments are described herein with reference to the drawings.

FIG. 1A is a front view of a device secured to a rope, according to an example embodiment.

FIG. 1B is a rear view of the device secured to the rope of FIG. 1A.

FIG. 1C is a rear perspective view of the first housing of the device of FIG. 1A.

FIG. 1D is a front perspective view of the first housing of the device of FIG. 1A.

FIG. 1E a front view of the first housing of the device of FIG. 1A.

FIG. 1F is a front view of a first portion of the device of FIG. 1A.

FIG. 1G is a front view of the first portion of the device of FIG. 1A secured to the rope.

FIG. 1H is a rear perspective view of the second housing of the device of FIG. 1A.

FIG. 2 is a system, according to an example embodiment.

FIG. 3 is a block diagram of a method of securing a device to a rope in an environment, according to an example embodiment.

### DETAILED DESCRIPTION

This description describes several example embodiments, at least one or more of which pertain to a data logging device. The data logging device may be affixed along a length of rope hanging in open space in an environment (e.g., in mid-air), and in some embodiments, may be slid along the length of rope until it reaches a target location along the length of rope.

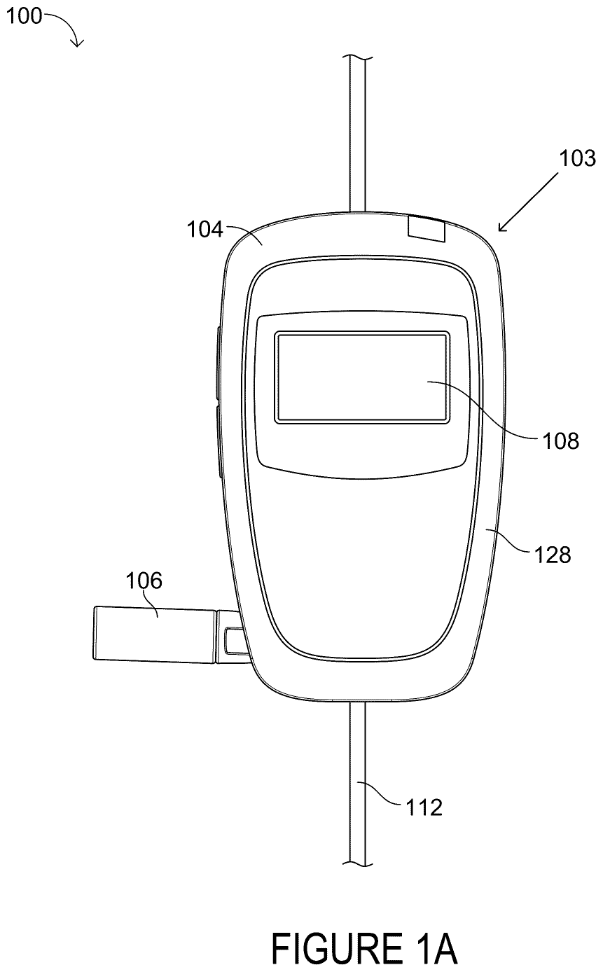

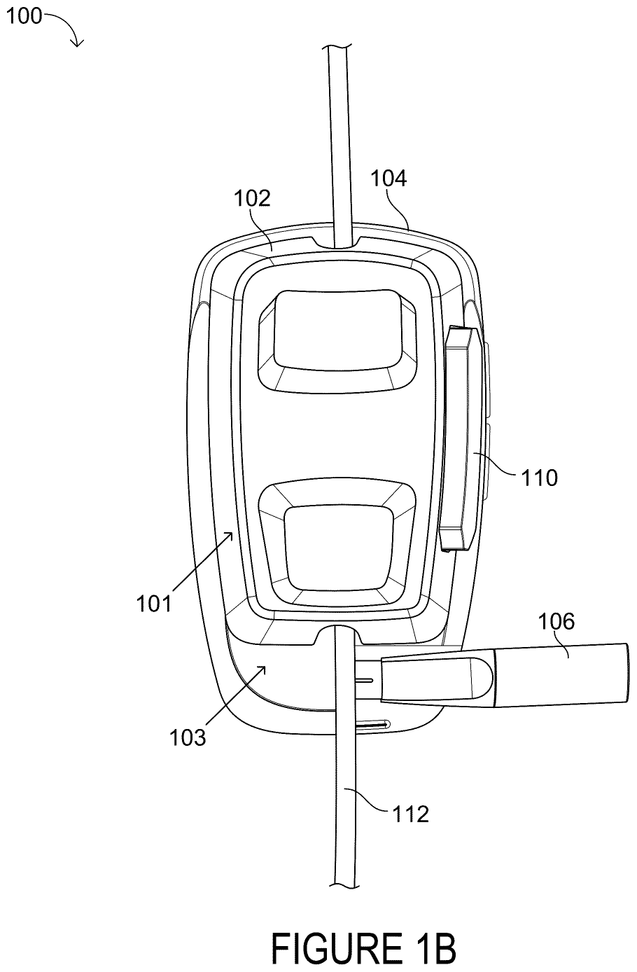

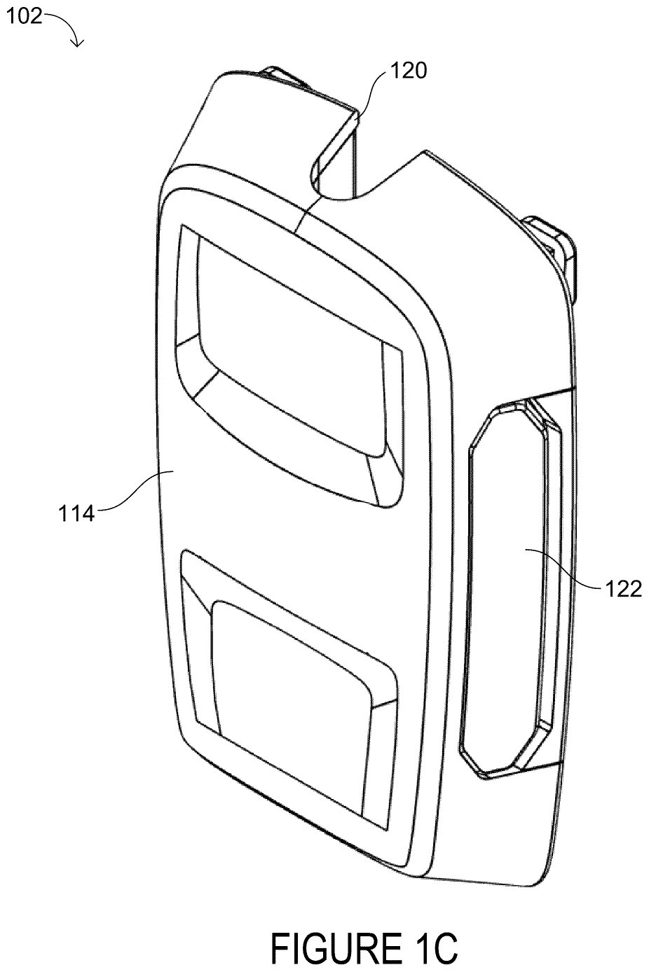

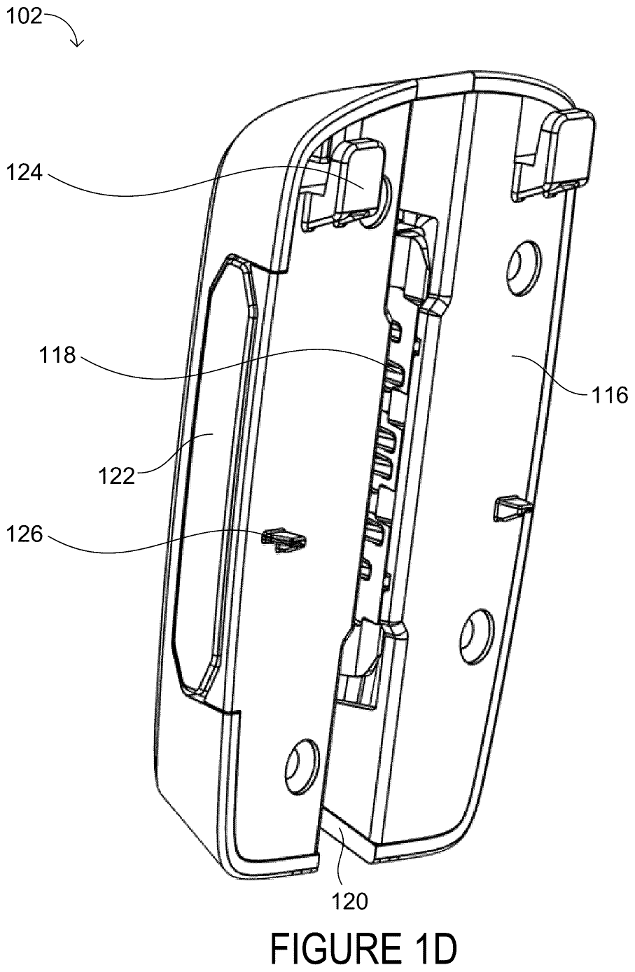

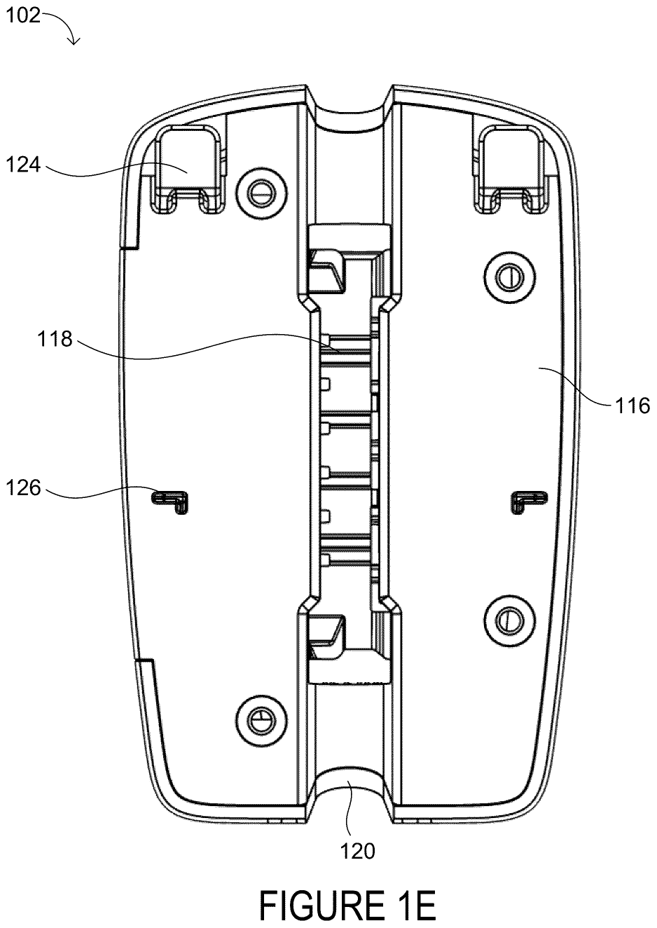

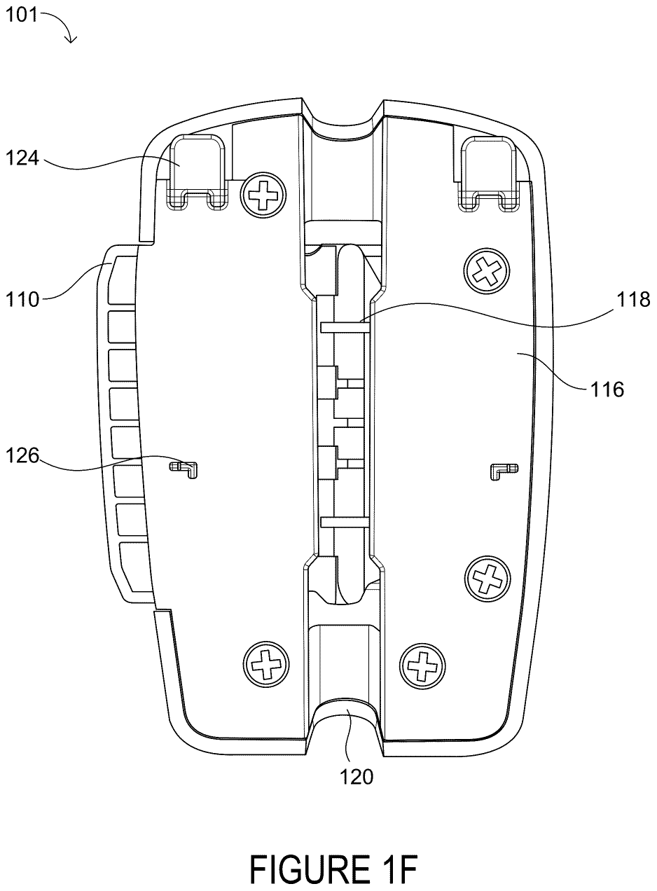

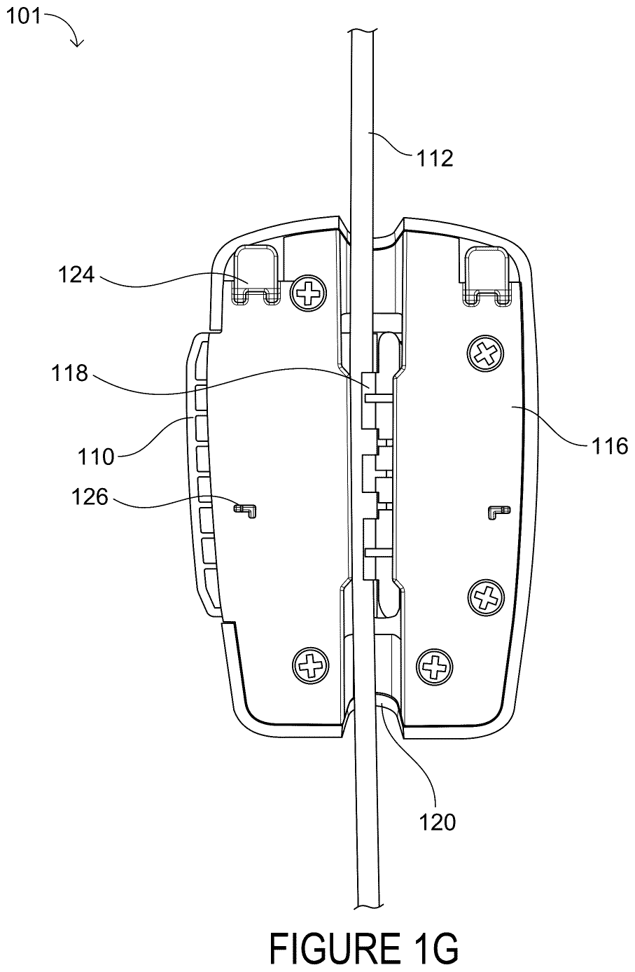

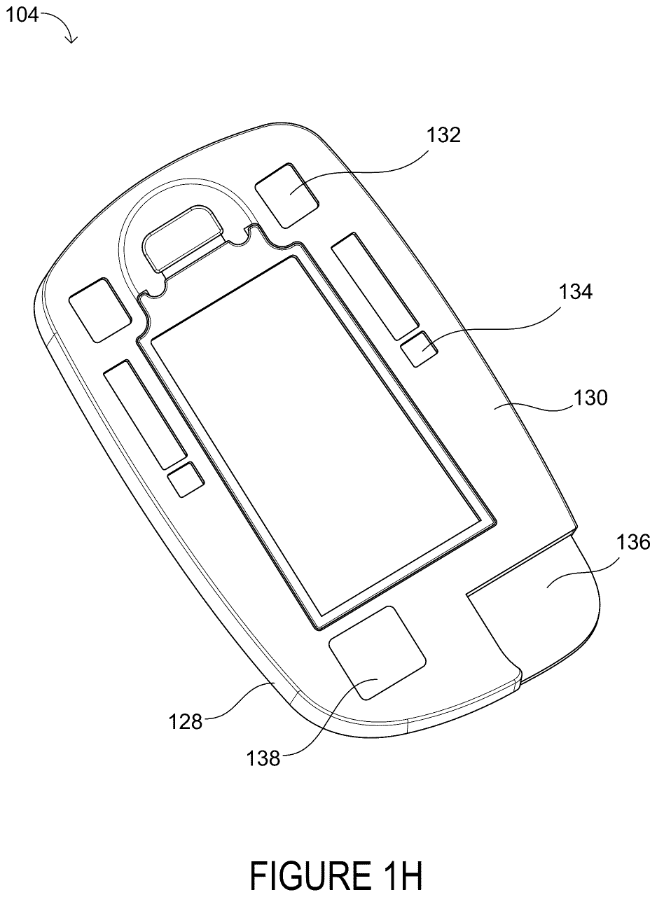

FIGS. 1A-1H depict a device 100. In some embodiments, the device 100 is a data-logging device. The device 100 is configurable to measure a temperature, a moisture content, or a pressure in an environment of the device 100. Further, a series of devices 100 may be positioned throughout the environment to develop a map of the measured input throughout the environment.

In some embodiments, the device 100 has a first portion 101 and a second portion 103. FIG. 1A is a front view of the device 100, displaying the second portion 103 of the device 100. FIG. 1B is a rear view of the device 100, displaying the first portion 101 in front of the second portion 103.

The first portion 101 includes a first housing 102 having an exterior facet 114, as shown in FIG. 1C, and an interior facet 116, as shown in FIGS. 1D and 1E. The exterior facet 114 may include a variety of features and shapes, such as one or more features and shapes so that a user's hand can handle the first portion 101. The interior facet 116 can also include a variety of components, such as the components described below.

The first portion 101, in some embodiments, includes a hook 124 on an upper portion of the interior facet 116 of the first housing 102. In some embodiments, the first portion includes two or more hooks 124 on the upper portion of the interior facet 116 of the first housing 102. Further, in some embodiments, the hook 124 is L-shaped. Further still, in some embodiments, the first portion 101 includes one or more indexing protrusions 126 on the interior facet 116 of the first housing 102.

The first portion 101, in some embodiments, includes a cleat 118 within a channel 120 on the interior facet 116 of the first housing 102. As shown in FIGS. 1F-1G, the channel 120 is configured to receive a portion of a rope 112. The first portion 101 further includes a depressible feature 110 configured to operate the cleat 118. In some embodiments, the depressible feature 110 is a button or a spring-loaded lever. In some embodiments, the depressible feature 110 is configured to open the cleat 118 when depressed. Further, in some embodiments, the channel 120 is configured to receive the portion of the rope 112 when the depressible feature 110 is depressed. Further still, in some embodiments, the cleat 118 is configured to secure the first portion 101 to the portion of the rope 112 via the cleat 118 when the depressible feature 110 is released.

In some embodiments, the second portion 103 includes a second housing 104 having an interfacing facet 128, as shown in FIG. 1A, and a retaining facet 130, as shown in FIG. 1H.

The second portion 103 includes a display 108 on the interfacing facet 128 of the second housing 104. In some embodiments, the display 108 indicates an input received by the device 100. Further, in some embodiments, the display 108 indicates another quantity, such as a battery charge of the device 100 or a time. In some embodiments, the display 108 is a graphical user interface. Further, in some embodiments, the input shown on the display 108 can be sent, via the device 100, to an external system.

The second portion 103 also includes a slot 132 on an upper portion of the retaining facet 130 of the second housing 104 such that the hook 124 of the first portion 101 is configured to be received by the slot 132 of the second portion 103 to couple the second portion 103 to the first portion 101. In some embodiments, when the hook 124 is L-shaped, the slot 132 is configured to hang the second portion 103 on the L-shaped hook 124 of the first portion 101.

In some embodiments, when the first portion 101 includes two or more hooks 124, the second portion 103 includes two or more slots 132 corresponding to the two or more hooks 124. Further, in some embodiments, the second portion 103 further includes an indentation 134 corresponding to the indexing protrusion 126 on the interior facet 116 of the first housing 102.

In some embodiments, the second portion 103 includes a sensor opening 136 in the retaining facet 130 of the second housing 104.

The device 100 further includes a sensor 106. The sensor 106 is received in the sensor opening 136 on the retaining facet 130 of the second portion 103. In some embodiments, the sensor 106 is configured to receive information regarding an input in an environment. For example, the input to the sensor 106 may be representative of at least one of a temperature in the environment, a moisture content in the environment, a pressure in the environment, or a CO₂ level in the environment. In some embodiments, the sensor 106 includes a thermocouple, thermistor, a resistance temperature detector, a relay, a humidity sensor, a differential pressure sensor, a CO₂ percentage sensor, and/or a temperature sensor without resistance. In some embodiments, the sensor 106 includes a universal sensor configured to measure electrical current from industry standard equipment, such as industry equipment with a 4-20mA, 0-5V, or 0-10V output. In some embodiments, the sensor 106 includes a combined sensor (e.g., a dual temperature and humidity sensor or a triple temperature, humidity, and CO₂ percentage sensor).

In some embodiments, the device 100 reduces rotation of the sensor 106 with respect to the first housing 102 and/or the second housing 104.

In some embodiments, the second portion 103 further includes a controller 138 in communication with the sensor 106. The controller 138 may determine when the sensor 106 is triggered to receive information regarding an input in an environment, such as activating the sensor 106 at a predetermined rate or activating the sensor 106 when the information regarding the input in the environment exceeds a predetermined threshold value. The sensor 106 may receive the information regarding the input in the environment and send the information to the controller 138. The controller 138 may record the information regarding the input in the environment locally and/or communicate the information to another device (e.g., a computing device 206).

In some embodiments, the controller 138 includes a processor, a memory, and a network interface. The processor may be one or more of any type of computer processing element, such as a central processing unit (CPU). The memory may be any form of computer-usable memory, including but not limited to random access memory (RAM), read-only memory (ROM), and non-volatile memory. The network interface may take the form of one or more wireline interfaces (e.g., Ethernet) or one or more wireless interfaces (e.g., IEEE 802.11 (Wi-Fi®), BLUETOOTH®, LoRaWAN®, or a wide-area wireless interface).

In the embodiment illustrated in FIG. 1H, the controller 138 is located adjacent to the sensor opening 136. In other embodiments, the controller 138 is disposed in another portion of the second portion 103.

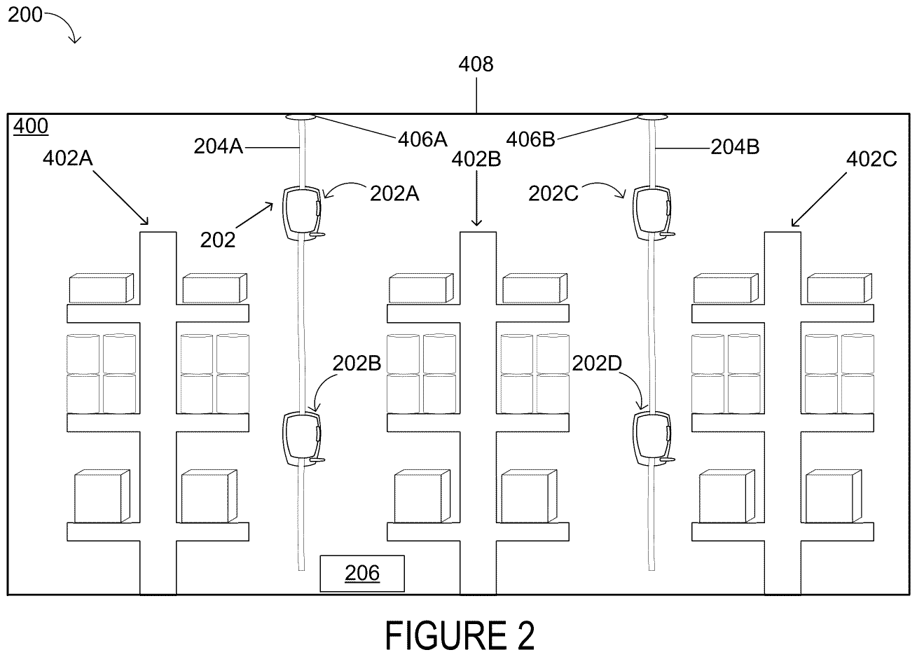

FIG. 2 shows a system 200 of data logging devices 202 in a warehouse 400, according to an example embodiment. In the embodiment illustrated in FIG. 2, the system 200 includes a first rope 204A and a second rope 204B, between shelving units 402A, 402B, and 402C of the warehouse 400. Further, one or more devices 202 are attached to each of the first rope 204A and second rope 2024B. Each of the one or more devices 202 in the system 200 may include any component of the device 100 described above with respect to FIGS. 1A to 1H. In the embodiment illustrated in FIG. 2, the system 200 includes four devices 202A-202D, with two devices 202A and 202B attached to the first rope 204A, and two devices 202C and 202D attached to the second rope 204B.

In order to generate a data map of an environment of the warehouse 400, the first rope 204A may be placed at a first position 406A along a ceiling 408 of the warehouse 400 and the second rope 204B may be placed at a second position 406B along the ceiling 408. By doing so, each device 201 may be positioned vertically along each of the first rope 204A and the second rope 204B to generate a data map of the environment of the warehouse 400 where there was previously not structure for placement of the devices 202 in target locations in the environment. Further, each device 202 may be moved along a length of respective rope (204A or 204B) by depressing the depressible feature 110 of the device 202 and sliding the rope through the open cleat 118 in the channel 120 of the device 202. As such, a height of the device 202 in the system 200 may be adjusted.

Further, in some embodiments of the system 200, the system 200 also includes a computing device 206 configured to receive the inputs from the sensor 106 of each device 201. Further, in some embodiments of the system 200, the computing device 206 is configured to output a map of the inputs received from the sensor 106 of each device 201. The outputted map may be indicative of data in the environment of the warehouse 400.

In some embodiments, the computing device 206 includes a processor, a memory, and a network interface. The processor of the computing device 206 may take the form of or be similar in form to the processor of the controller 138, the memory of the computing device 206 may take the form of or be similar in form to the memory of the controller 138, and the network interface may take the form of or be similar in form to the network interface of the controller 138.

In the embodiment illustrated in FIG. 2, the computing device 206 is remote from the devices 202A-202D. In other embodiments, the computing device 206 is disposed on one of the device 202A, device 202B, device 202C, and device 202D. For example, the controller of one of the device 202A, device 202B, device 202C, and device 202D may be configured to perform one or more functions of the computing device 206.

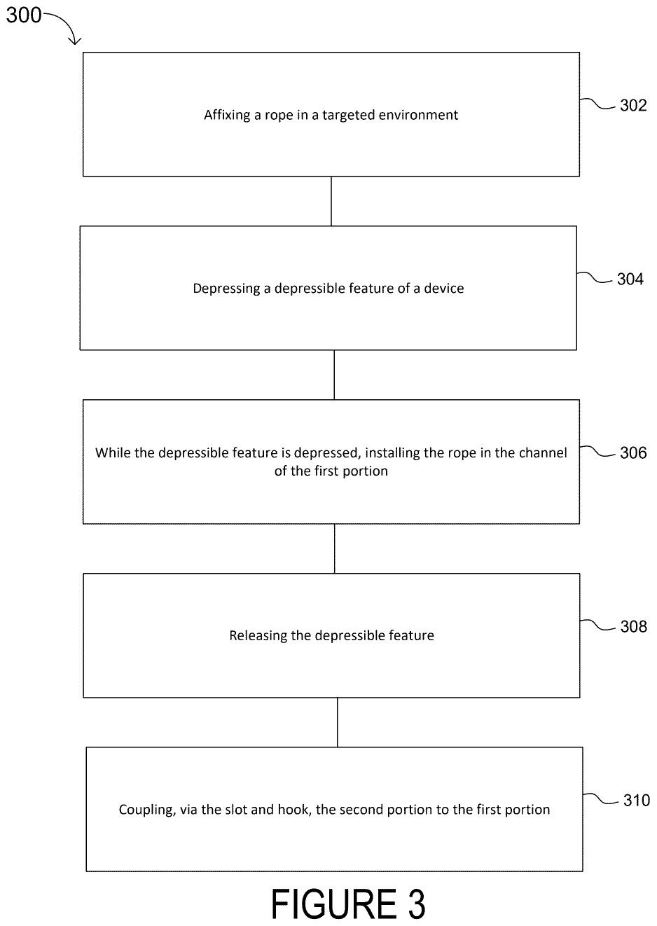

FIG. 3 is a block diagram of a method 300 for securing a device to a rope in an environment. As shown in FIG. 3, the method 300 includes one or more operations, functions, or actions as illustrated by blocks 302, 304, 306, 308, and 310. Any blocks may be performed in parallel, and/or in a different order than those described herein. Also, the various blocks may be combined into fewer blocks, divided into additional blocks, and/or removed based upon the desired implementation.

At block 302, the method 300 includes affixing a rope in an environment.

At block 304, the method 300 includes depressing a depressible feature of a device. The device has a first portion. The first portion includes a first housing having an exterior facet and an interior facet, a cleat within a channel on the interior facet of the first housing such that the channel is configured to receive a portion of a rope, a depressible feature configured to operate the cleat, and a hook on an upper portion of the interior facet of the first housing. The device also has a second portion. The second portion includes a second housing having an interfacing facet and a retaining facet, a display on the interfacing facet of the second housing, and a slot on an upper portion of the retaining facet of the second housing such that the hook of the first portion is configured to be received by the slot of the second portion to couple the second portion to the first portion. The device further has a sensor. The sensor is received in a sensor opening on the retaining facet of the second portion. The sensor is configured to receive information regarding an input in an environment of the device.

At block 306, the method 300 includes, while the depressible feature is depressed, installing the rope in the channel of the first portion. In some embodiments, installing the rope in the channel of the first portion involves laying the rope in the channel of the first portion.

At block 308, the method 300 includes releasing the depressible feature such that releasing the depressible feature secures the first portion to the rope.

At block 310, the method 300 includes coupling, via the slot and hook, the second portion to the first portion.

In one or all embodiments, the method 300 further includes moving the device along the rope. Moving the device along the rope, in some embodiments, includes depressing the depressible feature, while the depressible feature is depressed, sliding the device along the rope to a specific position of the device along the rope, and releasing the depressible feature in order to resecure the device to the rope.

In one or all embodiments, the method 300 further includes coupling the second portion to the first portion by hanging the slot on the hook of the device when the hook of the device is L-shaped.

In one or all embodiments, the method 300 includes coupling the second portion to the first portion by aligning an indexing protrusion with an indentation such that the first portion further comprises an indexing protrusion on the interior facet of the first housing and the second portion further comprises an indentation corresponding to the indexing protrusion on the interior facet of the first housing.

Although the device 100 and the devices 202 described above include the sensor 106, in other embodiments, a rope-clip assembly might not include the sensor 106. The rope-clip assembly may include any of the components of the device 100 described above with respect to FIGS. 1A-1G, except for the sensor 106. Thus, in some embodiments, the rope-clip assembly includes a first portion and a second portion. The first portion includes a first housing having an exterior facet and an interior facet, a cleat within a channel on the interior facet of the first housing such that the channel is configured to receive a portion of a rope, a depressible feature configured to operate the cleat, and a hook on an upper portion of the interior facet of the first housing. The second portion includes a second housing having an interfacing facet and a retaining facet, a display on the interfacing facet of the second housing, and a slot on an upper portion of the retaining facet of the second housing such that the hook of the first portion is configured to be received by the slot of the second portion to couple the second portion to the first portion.

Further, although the system 200 described above included devices 202, in other embodiments, a rope-clip system includes two or more rope-clip assemblies. The rope-clip system includes two or more ropes and at least two rope-clip assemblies. Each rope-clip assembly includes a first portion and a second portion. The first portion includes a first housing having an exterior facet and an interior facet, a cleat within a channel on the interior facet of the first housing such that the channel is configured to receive a portion of a rope, a depressible feature configured to operate the cleat, and a hook on an upper portion of the interior facet of the first housing. The second portion includes a second housing having an interfacing facet and a retaining facet, a display on the interfacing facet of the second housing, and a slot on an upper portion of the retaining facet of the second housing such that the hook of the first portion is configured to be received by the slot of the second portion to couple the second portion to the first portion.

Further, although the method 300 described above involved the device 100, in other embodiments a method for securing a rope-clip assembly to a rope in an environment is provided. The method includes affixing a rope in an environment and depressing a depressible feature of a rope-clip assembly. The rope-clip assembly has a first portion and a second portion. The first portion includes a first housing having an exterior facet and an interior facet, a cleat within a channel on the interior facet of the first housing such that the channel is configured to receive a portion of a rope, a depressible feature configured to operate the cleat, and a hook on an upper portion of the interior facet of the first housing. The second portion includes a second housing having an interfacing facet and a retaining facet, a display on the interfacing facet of the second housing, and a slot on an upper portion of the retaining facet of the second housing such that the hook of the first portion is configured to be received by the slot of the second portion to couple the second portion to the first portion. The method also includes, while the depressible feature is depressed, installing the rope in the channel of the first portion, releasing the depressible feature such that releasing the depressible feature secures the first portion to the rope, and coupling, via the slot and hook, the second portion to the first portion.

It should be understood that the arrangements described herein and/or shown in the drawings are for purposes of example only and are not intended to be limiting. As such, those skilled in the art will appreciate that other arrangements and elements (e.g., machines, interfaces, functions, orders, and/or groupings of functions) can be used instead, and one or more elements can be omitted altogether.

While various aspects and embodiments are described herein, other aspects and embodiments will be apparent to those skilled in the art. The various aspects and embodiments disclosed herein are for purposes of illustration and are not intended to be limiting, with the true scope being indicated by the claims, along with the full scope of equivalents to which such claims are entitled. It is also to be understood that the terminology used herein for the purpose of describing embodiments only, and is not intended to be limiting.

In this description, the articles “a,” “an,” and “the” are used to introduce elements and/or functions of the example embodiments. The intent of using those articles is that there is one or more of the introduced elements and/or functions.

In this description, the intent of using the term “and/or” within a list of at least two elements or functions and the intent of using the terms “at least one of,” “at least one of the following,” “one or more of,” “one or more from among,” and “one or more of the following” immediately preceding a list of at least two components or functions is to cover each embodiment including a listed component or function independently and each embodiment including a combination of the listed components or functions.

The use of ordinal numbers such as “first” and “second” and so on is to distinguish respective elements rather than to denote an order of those elements unless the context of using those terms explicitly indicates otherwise. Further, the description of a “first” element, such as a first rope, does not necessitate the presence of a second or any other element, such as a second rope.

What is claimed is:

1. A device comprising:
a first portion, wherein the first portion comprises:
a first housing having an exterior facet and an interior facet,
a cleat within a channel on the interior facet of the first housing, wherein the channel is configured to receive a portion of a rope,
a depressible feature configured to operate the cleat, and
a hook on an upper portion of the interior facet of the first housing;
a second portion, wherein the second portion comprises:
a second housing having an interfacing facet and a retaining facet,
a display on the interfacing facet of the second housing, and
a slot on an upper portion of the retaining facet of the second housing, wherein the hook of the first portion is configured to be received by the slot of the second portion to couple the second portion to the first portion; and
a sensor, wherein the sensor is received in a sensor opening on the retaining facet of the second portion, and wherein the sensor is configured to receive information regarding an input in an environment of the device.

2. The device of claim 1, wherein:
the first portion further comprises an indexing protrusion on the interior facet of the first housing, and
the second portion further comprises an indentation corresponding to the indexing protrusion on the interior facet of the first housing.

3. The device of claim 2, wherein, when second portion is coupled to the first portion, the indexing protrusion is received by the indentation.

4. The device of claim 1, wherein the hook is L-shaped.

5. The device of claim 4, wherein the slot is configured to hang the second portion on the L-shaped hook of the first portion.

6. The device of claim 1, further comprising a second hook on the upper portion of the interior facet of the first housing and a second slot on the upper portion of the retaining facet of the second housing corresponding to the second hook.

7. The device of claim 1, wherein the depressible feature is a button.

8. The device of claim 1, wherein the depressible feature is configured to open the cleat when depressed.

9. The device of claim 8, wherein the channel is configured to receive the portion of the rope when the depressible feature is depressed.

10. The device of claim 9, wherein the cleat is configured to secure the first portion to the portion of the rope via the cleat when the depressible feature is released.

11. The device of claim 1, wherein the display is configured to indicate the input received by the sensor.

12. The device of claim 1, wherein the input is representative of at least one of a temperature, a moisture content, or a pressure.

13. A method comprising:
affixing a rope in an environment;
depressing a depressible feature of a device, the device comprising:
a first portion, wherein the first portion comprises:
a first housing having an exterior facet and an interior facet,
a cleat within a channel on the interior facet of the first housing, wherein the channel is configured to receive a portion of a rope,
the depressible feature configured to operate the cleat, and
a hook on an upper portion of the interior facet of the first housing;
a second portion, wherein the second portion comprises:
a second housing having an interfacing facet and a retaining facet,
a display on the interfacing facet of the second housing, and
a slot on an upper portion of the retaining facet of the second housing, wherein the hook of the first portion is configured to be received by the slot of the second portion to couple the second portion to the first portion; and
a sensor, wherein the sensor is received in a sensor opening on the retaining facet of the second portion, and wherein the sensor is configured to receive information regarding an input in the environment of the device;
while the depressible feature is depressed, installing the rope in the channel of the first portion;
releasing the depressible feature, wherein releasing the depressible feature secures the first portion to the rope; and
coupling, via the slot and hook, the second portion to the first portion.

14. The method of claim 13, further comprising:
moving the device along the rope.

15. The method of claim 14,
depressing the depressible feature;
while the depressible feature is depressed, sliding the device along the rope to a desired position of the device along the rope;
releasing the depressible feature, wherein releasing the depressible feature resecures the device to the rope.

16. The method of claim 13, wherein coupling the second portion to the first portion further comprises hanging the slot on the hook wherein the hook is L-shaped.

17. The method of claim 13, wherein coupling the second portion to the first portion further comprises aligning an indexing protrusion with an indentation, wherein:
the first portion further comprises an indexing protrusion on the interior facet of the first housing, and
the second portion further comprises an indentation corresponding to the indexing protrusion on the interior facet of the first housing.

18. A system comprising,
two or more ropes, and
at least two devices, each device comprising:
a first portion, wherein the first portion comprises:
a first housing having an exterior facet and an interior facet,
a cleat within a channel on the interior facet of the first housing, wherein the channel is configured to receive a portion of a rope,
a depressible feature configured to operate the cleat, and
a hook on an upper portion of the interior facet of the first housing;
a second portion, wherein the second portion comprises:
a second housing having an interfacing facet and a retaining facet,
a display on the interfacing facet of the second housing, and
a slot on an upper portion of the retaining facet of the second housing, wherein the hook of the first portion is configured to be received by the slot of the second portion to couple the second portion to the first portion; and
a sensor, wherein the sensor is received in a sensor opening on the retaining facet
of the second portion, and wherein the sensor is configured to receive information regarding an input in an environment of the device.

19. The system of claim 18, wherein the system further comprises a computing device configured to receive the inputs from the sensor of each device.

20. The system of claim 19, wherein the computing device is configured to output a map of the inputs received from the sensor of each device, and wherein the map is indicative of data in an environment of the system.

21. A rope-clip assembly comprising:
a first portion, wherein the first portion comprises:
a first housing having an exterior facet and an interior facet,
a cleat within a channel on the interior facet of the first housing, wherein the channel is configured to receive a portion of a rope,
a depressible feature configured to operate the cleat, and
a hook on an upper portion of the interior facet of the first housing; and
a second portion, wherein the second portion comprises:
a second housing having an interfacing facet and a retaining facet,
a display on the interfacing facet of the second housing, and
a slot on an upper portion of the retaining facet of the second housing, wherein the hook of the first portion is configured to be received by the slot of the second portion to couple the second portion to the first portion.

22. A method comprising:
affixing a rope in an environment;
depressing a depressible feature of a rope-clip assembly, the rope-clip assembly comprising:
a first portion, wherein the first portion comprises:
a first housing having an exterior facet and an interior facet,
a cleat within a channel on the interior facet of the first housing, wherein the channel is configured to receive a portion of a rope,
the depressible feature configured to operate the cleat, and
a hook on an upper portion of the interior facet of the first housing;
a second portion, wherein the second portion comprises:
a second housing having an interfacing facet and a retaining facet,
a display on the interfacing facet of the second housing, and
a slot on an upper portion of the retaining facet of the second housing, wherein the hook of the first portion is configured to be received by the slot of the second portion to couple the second portion to the first portion;
while the depressible feature is depressed, installing the rope in the channel of the first portion;
releasing the depressible feature, wherein releasing the depressible feature secures the first portion to the rope; and
coupling, via the slot and hook, the second portion to the first portion.
